(19) United States
(12) Patent Application Publication
(10) Pub. No.: US 2002/0192626 A1
(43) Pub. Date: Dec. 19, 2002

(54) Apparatus for interactive rehabilitation support using gesture identification

(76) Inventors: Fritz Breimesser, Nuernberg (DE); Uwe Eisermann, Erlangen (DE); Hans Roettger, Muenchen (DE); Kal-Uwe Schmidt, Paoli, PA (US)

Correspondence Address: YOUNG & THOMPSON, 745 SOUTH 23RD STREET 2ND FLOOR, ARLINGTON, VA, 22202

(21) Appl. No.: 10/154,829

(22) Filed: May 28, 2002

(30) Foreign Application Priority Data
May 25, 2001 (DE) 10125653.1

(51) Int. Cl. G09B 23/28

(52) U.S. Cl. 434/262

(57) ABSTRACT

Apparatus for interactive rehabilitation support using gesture identification

Apparatus for interactive rehabilitation support by means of computer-aided training carried out independently by the patient using an input apparatus for the patient's input commands, the input apparatus comprising a gesture identification system as an additional input medium.

The invention relates to an apparatus for interactive rehabilitation support by means of computer-aided training carried out independently by the patient using an input apparatus for the patient's input commands.

A rehabilitation process involves a need for therapy both for cognitive and motor disorders. Computer-aided training carried out independently by the patient and supervised by the therapist can make a significant contribution to success in this context.

Computer-aided training has already become established in the rehabilitation of cognitive disorders. More recent developments also permit interactive, individual training to the extent of “tele-rehabilitation”, where the patient performs the exercises prescribed for him at home. A system suitable for this purpose is described in U.S. Pat. No. 5,711,671, for example. A similar system (“Rehab Assistant”) has been designed by the applicant and has already undergone successful trials with clinics. To date, however, people with extreme disabilities or motor disorders cannot carry out this method of training owing to a lack of appropriate input media.

For cognitive training, the input media customary on PCs, such as the keyboard, if appropriate including in special designs, mouse, touchscreen or joystick, have been used to date. In the special cases mentioned of extreme disability or motor disorders, special voice controllers or tracking systems are also used. For motor training, there are no satisfactory input media, however.

The invention is therefore based on the object of designing an apparatus of the type mentioned in the introduction such that a new individually adjustable input channel is available even for users with complex disabilities.

The invention achieves this object by virtue of the input apparatus comprising a gesture identification system as an additional input medium, the gesture identification system preferably being able to be programmed for a specific patient in repeated adaptation phases.

Although many variants of gesture identification systems have already been proposed, they always involve the user needing to adjust himself to prescribed standard situations, such as in the case of gesture identification systems for identifying and translating sign language or lip language for deaf-mutes. Patients who are neither able to operate an input medium such as a mouse or keyboard manually nor able to emulate particular gestures exactly cannot use these known gesture identification systems for anything.

For this reason, unlike in the case of previously known gesture identification systems, the invention provides for the system first to comprise patient-specific adaptation phases in which the system learns the individual reactions and their association with particular input commands. In this case, the set of commands will be limited, by way of example, to a few commands such as Yes, No, Left, Right, Stop, or the like, the procedure for learning these commands in the adaptation phase, which learning naturally needs to be done together with the therapist before the actual home training, being such that the patient responds to a command presented to him with a corresponding reaction of the body, for example waving his hand, nodding his head, or the like, which is then “learned” by the system as a gesture command for the corresponding command in appropriate repeats.

In this context, it has also been found to be expedient for the gesture identification system, before any subsequent use as an input apparatus for the training program, always to play back all stored symbols first and to compare the user's gestures with the stored gesture data in order—possibly after a new update—to establish whether the patient continues to make the same identifiable gestures for the individual commands or whether it is necessary either to modify the stored gestures for the corresponding command or else to request support, for example by means of an online connection to the clinic or to the therapist.

In this case, in one embodiment of the invention, the gesture identification system can be designed on the basis of Hidden Markov Models (HMM).

The inventive system affords a series of fundamental advantages over the prior art.

Firstly, it allows computer-aided cognitive training even for patients who had previously been excluded therefrom on account of the degree of their disability. It also results in extension of the training provided to motor exercises with large degrees of freedom in terms of movement types and observable volume, with, in particular, both immediate feedback to the patient regarding the quality of his motor exercises also being possible using automatic classification, in which case the classification into quality classes can be stipulated by positive and negative examples during the “Teach-in”, and corresponding reports being able to be returned to the therapist.

Finally, the inventive system makes it possible to extend the computer-aided training by new components which are possible only with gesture identification, such as special movement training and gesture games, for example spoofing. Thus, by way of example, the computer can play the popular game paper/scissors/stone with the patient, where the flat outstretched hand means paper, the spread middle and index fingers means scissors and the clenched fist means stone. This can naturally be modified for a disabled patient by virtue of the computer learning other gestures for the corresponding concepts in the patient-specific adaptation phase, and then accepting them later.

Other advantages, features and details of the invention can be found in the description below of an exemplary embodiment and with reference to the drawing, in which:

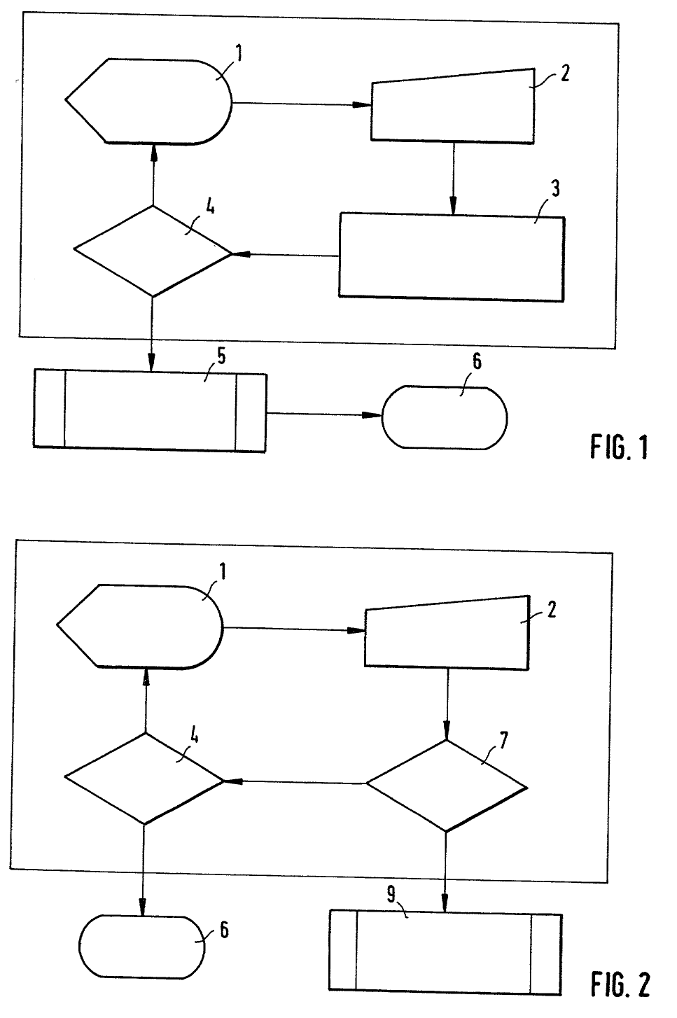

FIG. 1 shows a diagrammatic representation of the adaptation process, where the symbols or commands are assigned corresponding gestures of the patient,

FIG. 2 shows the check to be carried out with a gesture identification system each time before a training program is used, in order to check the current gestures of the patient with the stored data, and

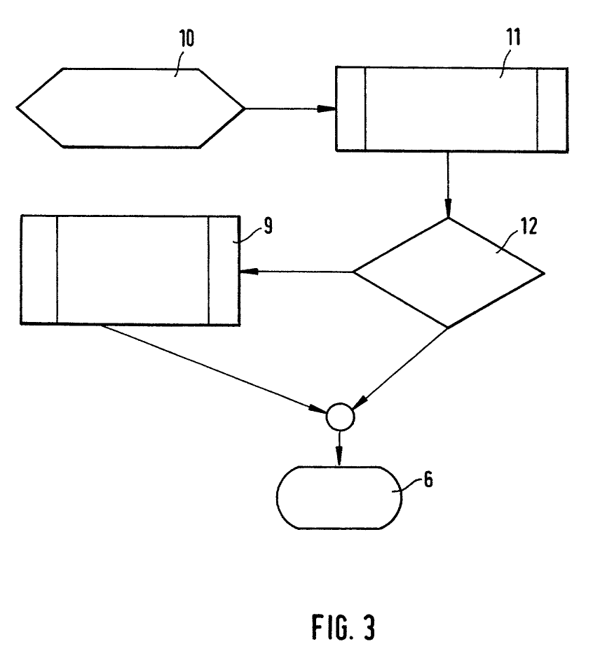

FIG. 3 shows a flowchart for computer-aided rehabilitation training using an input apparatus comprising such a gesture identification system.

For all the symbols in question—in this context, the term symbols also includes all possible input commands, such as Stop, Forward, Back, Left, Right, or the like—a respective symbol i is shown on the screen in an adaptation phase (shown in FIG. 1) together with the therapist, and following this presentation of the symbol the reaction of the patient, that is to say his subsequently made gestures or hand movement or the like, are/is recorded. The step 1 of presenting the symbol i is thus followed by the step 2 of identifying the reaction and, as step 3, stipulation of whether the corresponding reaction characteristic is suitable for using a gesture identification program to allow the computer to identify from this reaction, that is to say from this special gesture, that the patient means the currently shown symbol i from a series of symbols 1-m. Step 4 records whether all the symbols have been covered by reactions of the patient in this manner. If this is not the case, the next symbol i+1 is called up again in step 1. If all the symbols have been identified and their associated gestures have been accepted, the adaptation pattern is stored in step 5, so that the actual rehabilitation training can then be started as step 6.

In the later checking program before any training for rehabilitation support using a computer, the individual symbols are again presented in succession for all the symbols in step 1, with the reaction of the patient again being checked in step 2, and a step 7 establishing whether the reaction matches the adaptation pattern's stored reaction in step 5 in FIG. 1 in as much as the system has assigned the symbol i to said reaction. If this is the case, step 4 checks whether all the symbols have been identified, and if not there is a return to step 1 and the next symbol is called up. If all the symbols have been identified, however, the training program is started (step 6). If, on the other hand, the patient's reaction to presentation of the symbol i does not correspond to the stored pattern in the identification step 7, then the adaptation method shown in FIG. 1 is restarted, which is shown in FIG. 2 as step 9.

Using this adaptation method and the gesture check shown in FIGS. 1 and 2, a training session using the gesture control is shown schematically in FIG. 3. When the system has been started in step 10, the gesture check shown in FIG. 2 is carried out, shown in FIG. 3 as step 11. If this gesture check reveals in step 12 that a new adaptation phase is necessary, the procedure advances to the adaptation method shown in FIG. 1 (step 9) in FIG. 3. If readaptation is not necessary, however, the training program 6 is started directly, as is also the case after the adaptation process has been carried out again in step 13.

1. An apparatus for interactive rehabilitation support by means of computer-aided training carried out independently by the patient using an input apparatus for the patient's input commands, characterized in that the input apparatus comprises a gesture identification system as an additional input medium.

2. The apparatus as claimed in claim 1, characterized in that the gesture identification system can be programmed for a specific patient in repeated adaptation phases.

3. The apparatus as claimed in claim 2, characterized in that the gesture identification system is designed on the basis of Hidden Markov Models (HMM).

4. The apparatus as claimed in one of claims 1 to 3, characterized in that, before use as an input apparatus for the training program, the gesture identification system plays back all stored symbols and compares the user's gestures with the stored gesture data.

5. The apparatus as claimed in one of claims 1 to 4, characterized in that the supervising center (clinic or therapist) can access the stored gesture data.

6. The apparatus as claimed in one of claims 1 to 5, characterized in that the training program comprises movement training and gesture games.

7. The apparatus as claimed in one of claims 1 to 6, characterized in that it comprises a system for quality assessment of the motor exercises using automatic classification.

8. The apparatus as claimed in claim 7, characterized in that the quality class classification can be stipulated in the course of the “Teach-in” during the adaptation phases.
